(19) United States
(12) Patent Application Publication
(10) Pub. No.: US 2012/0192669 A1
(43) Pub. Date: Aug. 2, 2012

(54) FRONT/REAR WHEEL BRAKE CONTROL DEVICE

(76) Inventor: JEN-FA LO, TAOYUAN (TW)

(21) Appl. No.: 13/311,611

(22) Filed: Dec. 6, 2011

(30) Foreign Application Priority Data
Jan. 31, 2011 (TW) 100202208

(51) Int. Cl. B62L 3/08; F16C 1/16; B62L 3/02; F16C 1/12

(52) U.S. Cl. 74/471 R

(57) ABSTRACT

A front/rear brake control device applicable for bicycles, electric bicycles or motorcycles includes a first driving member and a second driving member accommodated in a control member, coupled to each other and brake lines of the rear and front wheels respectively, and moved in the control member reciprocally. The first driving member is coupled to the brake handle through the control line, and the second driving member is delayed and driven by the first driving member. When the brake handle is operated, the first driving member links and moves the corresponding brake line to brake the rear wheel, and then the delayed and driven second driving member brakes the front wheel by the corresponding brake line, such that the brake handle of the bike body can be operated to brake the rear wheel first, and then the front wheel to achieve a safe, comfortable and sectional braking operation.

### BACKGROUND OF THE INVENTION

1. Field of the Invention

The present invention relates to an improved front/rear brake control device, in particular to the brake control device featuring a simple assembly and an easy and convenient operation and providing a safer and more comfortable transportation means such as a bicycle, an electric bicycle or a motorcycle.

2. Description of the Prior Art

As front and rear wheels of a general bicycle or motorcycle are installed with a brake separately, and the brakes are connected to the left and right brake handles through a brake line, wherein the left brake handle is provided for controlling the braking of the rear wheel, and the right brake handle is provided for controlling the braking of the front wheel. In general, the left and right brake handles are installed on left and right handles of the bicycle or motorcycle respectively, so that a rider's left and right hands can control the braking of the rear wheel and the front wheel respectively. In addition, the left and right brake handles can be operated at a normal traveling speed and controlled to achieve retarding, braking and stopping effects. However, the following situation may occur easily in an emergency brake or an instant retardation or braking operation at the moment of high-speed riding:

1. When the rider's right hand presses the right brake handle for the braking operation of the front wheel only, the rear wheel keeps rolling forward to push a bike body, so that the bike body has the risk of being toppled over easily.

2. When the rider's left hand presses the left brake handle for the braking operation of the rear wheel only, the front wheel keeps rolling forward to roll and drag the bike body, so that the bike body has the risk of sliding and causing an unsecured steering.

3. When the rider's left and right hands press the left and right brake handles simultaneously for the braking operation of the rear and front wheels, the front and rear wheels are stopped immediately, and the inertia of the bike may move the rider forward to cause an uncomfortable ride or even endanger the rider.

### SUMMARY OF THE INVENTION

Therefore, it is a primary objective of the present invention to provide an improved front/rear wheel brake control device to improve the aforementioned drawbacks and provide the effects of safe braking and comfortable riding.

To achieve the aforementioned objective, the present invention accommodates a first driving member and a second driving member in a control member, and the first and second driving members are coupled to brake lines of the rear wheel and front wheel respectively, and the first and second driving members are coupled with each other and moved back and forth in the control member, wherein the first driving member is coupled to the brake handle through the control line, and the second driving member is delayed and driven by the first driving member; such that when the brake handle is operated, the first driving member will be linked and moved to brake the rear wheel corresponding to the brake line, and the delayed and driven second driving member will brake the front wheel corresponding to the brake line, so as to achieve the safe, comfortable, and sectional braking operation effect by braking the rear wheel first and then immediately braking the front wheel by operating the brake handle while the bike body is moving.

The objects, technical characteristics, and effects will become apparent with the detailed description of a preferred embodiment and the illustration of related drawings as follows.

### BRIEF DESCRIPTION OF THE DRAWINGS

FIG. 1 is a schematic planar view of a preferred embodiment of the present invention;

FIG. 2 is an exploded view of FIG. 1;

FIG. 3 is a first schematic planar view of a braking operation in accordance with a preferred embodiment of the present invention; and

FIG. 4 is a second schematic planar view of a braking operation in accordance with a preferred embodiment of the present invention.

### DETAILED DESCRIPTION OF THE PREFERRED EMBODIMENTS

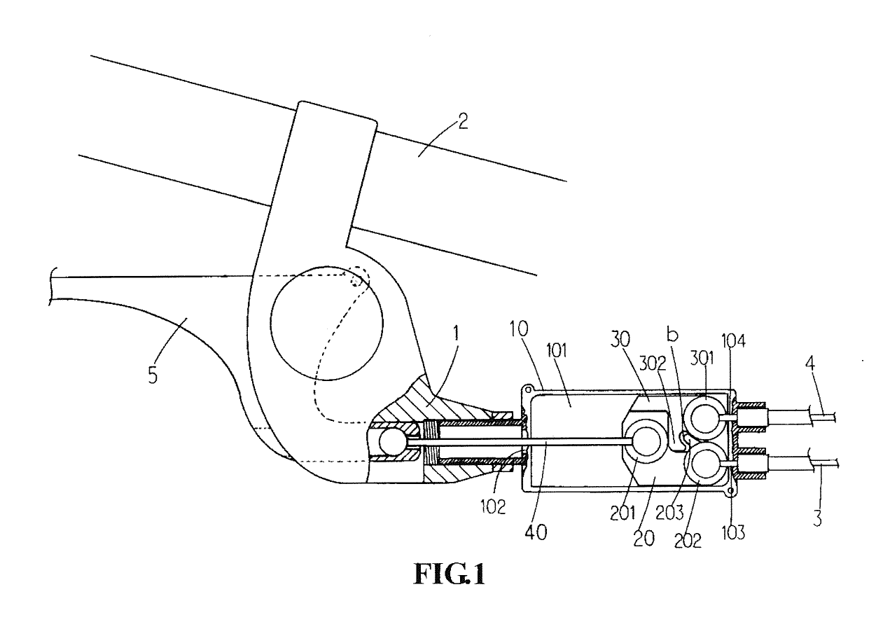

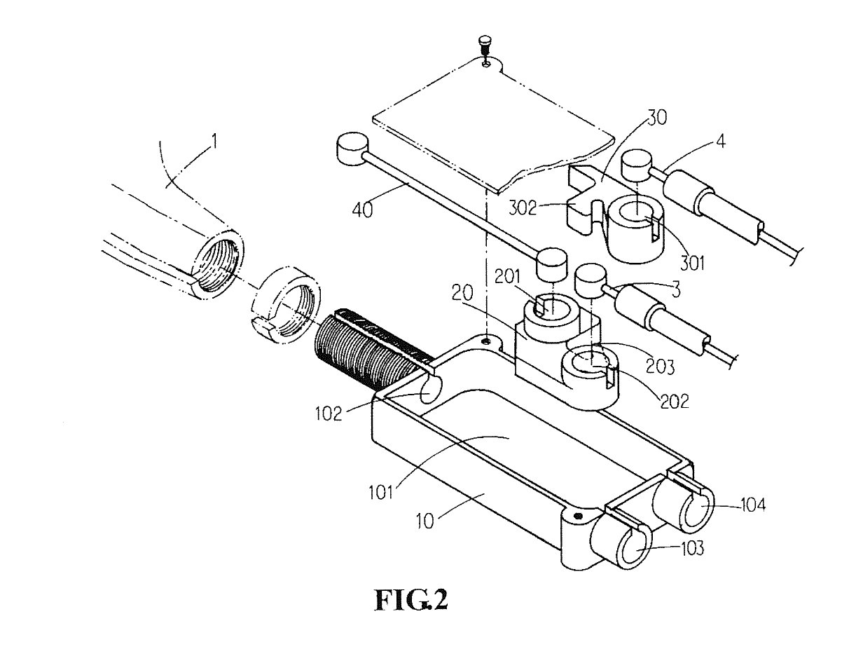

With reference to FIGS. 1 and 2 for an improved front/rear wheel brake control device of the present invention, the front/rear wheel brake control device comprises: a control member 10, installed at the brake handle body 1 or the bike handle 2 or another position of the bike body, and having an accommodating portion 101, a through hole 102 formed at an end of the accommodating portion 101 and interconnected to the outside, left and right through holes 103, 104 formed at the other end of the accommodating portion 101 and interconnected to the outside; a first driving member 20, installed on a side inside the accommodating portion 101 of the control member 10 and capable of being moved back and forth, and having a hinge portion 201, 202 formed separately at both ends of the first driving member 20, and a connecting latch 203 disposed on a side of the first driving member 20, and the two hinge portions 201, 202 are coupled to the through hole 102 at an end of the control member 10 and the through hole 103 on a side of the other end of first driving member 20, wherein the brake line 3 at an end hinge portion 202 is provided for passing through the through hole 103 on a side of the control member connected to a rear wheel brake (not shown in the figure); a second driving member 30, installed on the other side inside the accommodating portion 101 of the control member 10, and having a hinge portion 301 disposed at an end of the second driving member 30, and a connecting latch 302 formed on a side of the second driving member 30, wherein the hinge portion 301 is corresponsive to the through hole 104 on the other side of an end of the control member 10, and the brake line 4 connected to a front wheel brake (not shown in the figure) is passed through the through hole 104 and installed to the control member 10, and the connecting latch 302 is coupled and combined with the connecting latch 203 of the first driving member 20, and a connecting gap b with a predetermined distance is reserved; a control line 40, with an end passing through the through hole 102 at an end of the control member 10 and then installed to the hinge portion 201 at the other end of the first driving member 20, and the other end of the control line 40 being installed to the brake handle 5.

With the present invention, the brake lines 3, 4 coupled to the rear and front wheel brakes are coupled to the first and second driving members 20, 30 in the control member 10 respectively, and the first and second driving members 20, 30 are coupled and combined with each other, and the first driving member 20 is coupled to a brake handle 5 through the control line 50, so that a rider can simply operate the brake handle 5 to achieve the purposes and effects of controlling and operating the front and rear wheel brakes. In other words, the rider just needs to operate the brake handle 5 to brake the front and rear wheel brakes, and thus the motorcycle or bicycle simply requires installing one brake handle 5, so as to achieve the effects of lowering the cost, simplifying the assembling process, and provide an easy and convenient operation.

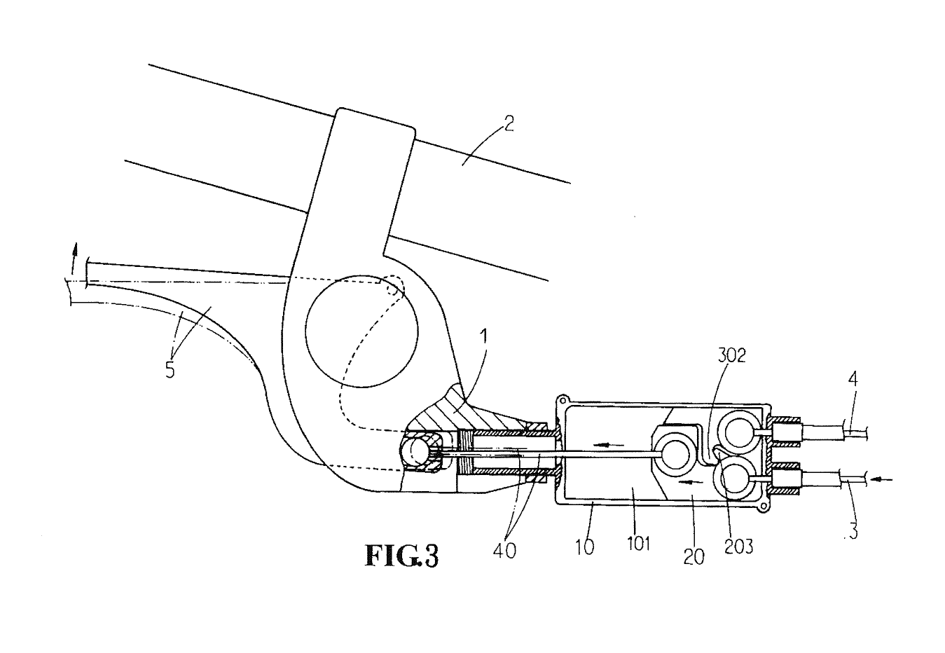

When a rider is riding the motorcycle or bicycle of the present invention without using the brakes, the first and second driving members 20, 30 installed at the rear and front wheel brake lines 3, 4 push an end of accommodating portion 101 of the control member 10 (as shown in FIG. 1), so that a predetermined connecting gap b is formed between the connecting latches 203, 302. When the rider presses the brake handle 5 for a braking operation, the control line 50 coupled to the brake handle 5 and the first driving member 20 will pull the first driving member 20 directly to move forward as shown in FIG. 3, so that the brake line 3 will be linked to drive the rear wheel brake to brake the rear wheel. In the meantime, since the predetermined connecting gap b is reserved between the connected first and second driving members 20, 30, therefore when the forward movement of the first driving member 20 drives the corresponding brake line 3 to brake the rear wheel brake, the second driving member 30 and the front wheel brake line 4 remain still at that time, and wait till the first driving member 20 continues to move forward to close the connecting gap b, the first driving member 20 will be driven together to provide a delayed operation.

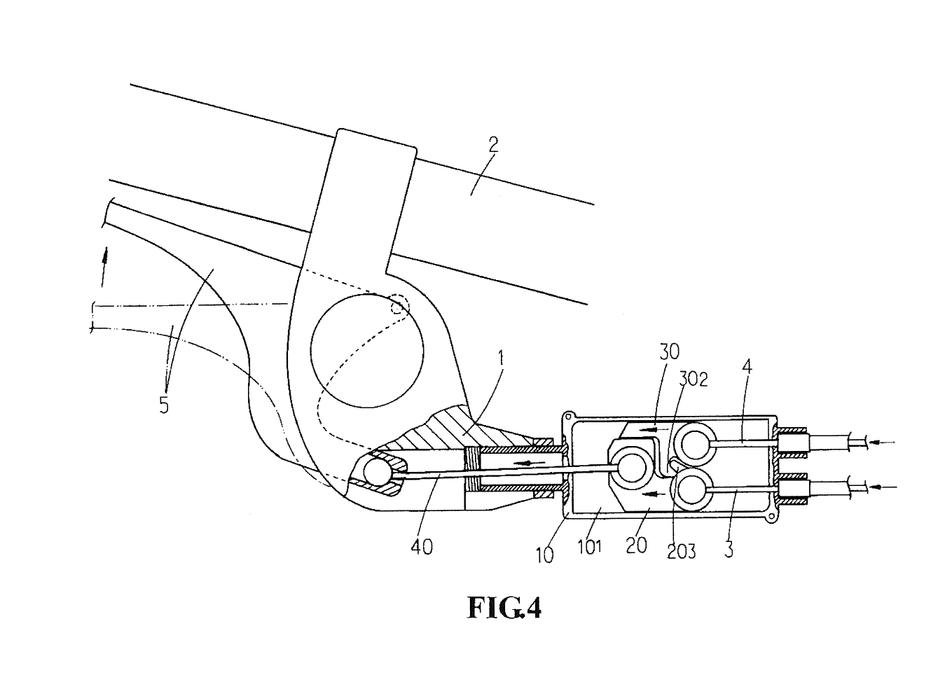

With reference to FIG. 4, if the brake handle 5 is pressed continuously, so that when the control line 50 keeps pulling the first driving member 20 to move forward, the brake line 3 will keep pulling and driving the rear wheel brake to brake the rear wheel, and the second driving member 30 coupled to the first driving member 20 will be driven to move forward, so that the brake line 4 will also drive the corresponding front wheel brake to brake the front wheel. Therefore, the same brake handle 5 can be pressed to achieve the braking operation of the front and rear wheel brakes.

Since the first and second driving members 20, 30 have a connecting gap b between them, therefore when the brake handle 5 is pressed, the rear wheel brake responds faster than the front wheel brake. If the brake handle 5 is pressed to brake a moving bike (including motorcycle or bicycle), the rear wheel of the motorcycle and bicycle will be braked first and then the front wheel will be braked to achieve the expected effect of braking the bike naturally. In the meantime, the bike body can be maintained more stable and balance to achieve the safety of riding the bike. Of course, the sectional braking operation by braking the rear wheel first and then braking the front wheel can relieve the inertia of the moving bike body sufficiently to reduce a forward leaning action of the rider, so as to achieve the effect of improving the comfortability and safety.

After the brake handle 5 is released, the front and rear wheel brakes resume their original positions, and the first and second driving members 20, 30 are still pulled smoothly by the corresponding brake lines 3, 4 to return to their positions (as shown in FIG. 1) and prepare for the next braking operation.

In other words, the present invention at least has the following advantages:

1. Features a simple manufacture, an easy assembling, and a convenient, cost-effective and quick application.

2. Simplify the number of brake handles to lower the cost.

3. Simplify the braking operation to provide an efficient operation and improve the safety and comfortability of the braking operation.

What is claimed is:

1. An improved front/rear brake control device, comprising:
a control member installed on a bike body, having an accommodating portion, a through hole formed at an end of the accommodating portion and connected to the outside, and two through holes formed at the other end of the accommodating portion and connected to the outside;
a first driving member, installed on a side in the accommodating portion of the control member, and movable back and forth, and having a hinge portion disposed separately at both ends of the first driving member, and a connecting latch disposed on a side of the first driving member, wherein the two hinge portions correspond to the through hole at an end of the control member and the through hole at an other end of the control member, and one of the hinge portions is provided for passing and installing a brake line coupled to a rear wheel brake to the through hole on the control member;
a second driving member, installed on the other side inside the accommodating portion of the control member, and having a hinge portion disposed at an end of the second driving member, and a connecting latch disposed at a side of the second riving member, wherein the hinge portion is corresponsive to through hole on the other side of an end of the control member, and provided for passing the brake line connected to the front wheel brake through the through hole of the control member, and the connecting latch is coupled and combined with the connecting latch of the first driving member, and a connection gap with a predetermined distance is reserved between the connecting latch of the first driving member and the connecting latch of the second driving member; and
a control line, having an end passing through the through hole at an end of the control member and installed to the member hinge portion at the other end of the first driving, and the other end being installed to the brake handle.

2. The improved front/rear brake control device of claim 1, wherein the control member is installed on a brake handle body of the bike body.

3. The improved front/rear brake control device of claim 1, wherein the control member is installed on a bike handle of the bike body.
